(19) United States
(12) Patent Application Publication
(10) Pub. No.: US 2010/0216350 A1
(43) Pub. Date: Aug. 26, 2010

(54) Foldable connection structure

(75) Inventor: Hong-Chi Yu, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: WALTON ADVANCED ENGINEERING INC., Kaohsiung City (TW)

(21) Appl. No.: 12/385,028

(22) Filed: Mar. 30, 2009

(30) Foreign Application Priority Data
Feb. 26, 2009 (TW) 098106084

(51) Int. Cl. H01R 13/502

(52) U.S. Cl. 439/701

(57) ABSTRACT

The present invention relates to a foldable connection structure, including a foldable plug. The foldable plug contains at least a connection part, in which the foldable plug has metal contacts being compatible with a data transmission interface and is electrically connected with an electronic device being compatible with the data transmission interface through the metal contacts.

### FIELD OF THE INVENTION

The present invention relates to a foldable connection structure, and more particularly to one applicable to all sorts of data transmission interfaces.

### BACKGROUND OF THE INVENTION

As a result of rapid growth of electronic technology, connection structures with various data transmission interfaces have been already extensively applied to a multitude of electronic devices. For example, Universal Serial Bus (USB), External Serial ATA (e-SATA), and so forth, all are the conventional data transmission interfaces employed so far. Please refer to FIG. 1-1 and FIG. 1-2, in which the USB plug 3 and e-SATA plug 4 shown therein are the connection plugs for the conventional data transmission interfaces at present. However, while the types of connection plugs employed are more and more diversified and the product designs all demand for a light, thin and tiny profile, the conventional connection plugs can hardly meet the product design requirement to be light, thin and tiny.

Therefore, it is necessary to design a connection structure for resolving the aforementioned technical issue in association with the connection plug.

### SUMMARY OF THE INVENTION

In accordance with a primary aspect of the present invention, a foldable connection structure is provided. The foldable connection structure has the characteristics of being smaller, lighter and thinner.

To achieve the aforementioned aspects, the primary skill employed by the present invention enables the foldable connection structure to include a foldable plug and a main body. The foldable plug contains at least a first connection part, at least a second connection part and a plurality of metal contacts being compatible with a data transmission interface, and is electrically connected with an electronic device being compatible with the data transmission interface through the metal contacts. The main body contains at least an electronic component and is electrically connected with the foldable plug.

The function and effect of the present invention makes its design more flexible by reducing the product size of the foldable connection structure so as to comply with the design requirement of being light, thin and tiny.

The foregoing and other features and advantages of the present invention will be more clearly understood through the following descriptions with reference to the drawing, wherein:

### BRIEF DESCRIPTION OF THE DRAWINGS

FIG. 1-1 is a full schematic diagram showing a conventional USB plug;

FIG. 1-2 is a full schematic diagram showing a conventional e-SATA plug;

FIG. 2 is a schematic diagram showing the first preferred embodiment of the present invention;

FIG. 3 is a schematic diagram showing the second preferred embodiment of the present invention;

FIG. 4 is a schematic diagram showing the third preferred embodiment of the present invention;

FIG. 5 is a schematic diagram showing the fourth preferred embodiment of the present invention;

FIG. 6 is a schematic diagram showing the fifth preferred embodiment of the present invention; and

FIG. 7 is a schematic diagram showing the sixth preferred embodiment of the present invention.

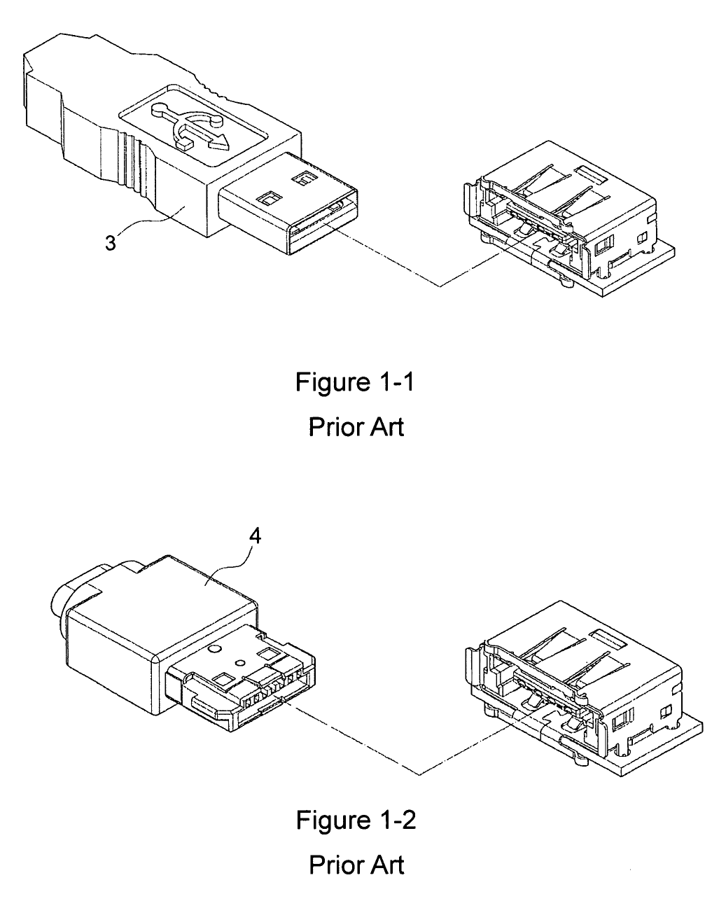

### DETAILED DESCRIPTION OF THE PREFERRED EMBODIMENT

The present invention will now be described more specifically with reference to the following six preferred embodiments of the present invention. It is to be noted that the following descriptions of preferred embodiments of this invention are presented herein for the purpose of illustration and description only; it is not intended to be exhaustive or to be limited to the precise form disclosed.

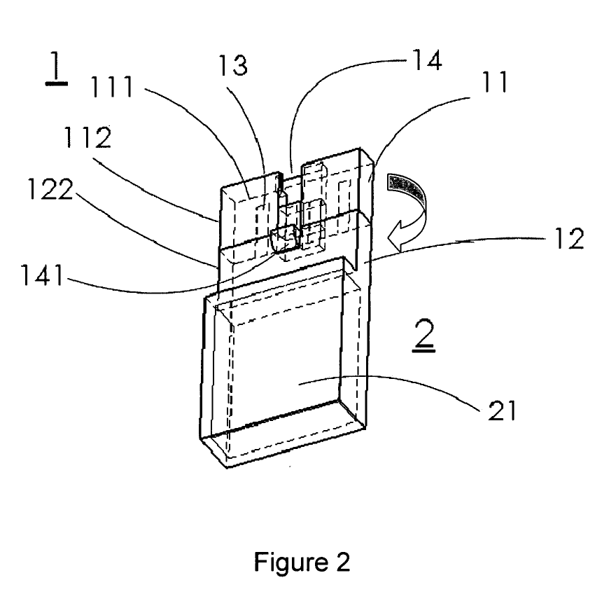

Please refer to FIG. 2 which shows the first preferred embodiment of the foldable connection structure in accordance with the present invention and includes a foldable plug 1 containing at least a first connection part 11 and at least a second connection part 12, in which the foldable plug 1 has metal contacts 13 being compatible with a data transmission interface and is electrically connected with an electronic device being compatible with the data transmission interface through the metal contacts 13, the metal contacts 13 can be compatible with a USB transmission interface, or an e-SATA transmission interface (only the USB transmission interface is shown as an example), and the length of any end face of the first connection part is not greater than 14 mm and the length of any end face of the second connection part is not greater than 14 mm; and a main body 2 containing at least an electronic component 21.

The main body 2 is electrically connected with the foldable plug 1. The foldable plug 1 and the main body 1 are integrally formed. The metal contacts are disposed on a surface 111 of the first connection part 11. The foldable plug 1 has at least a track 14, which is provided on a surface (112, 122) of the first connection part 11 and the second connection part 12 opposing to the surface having the metal contacts 13, communicates with the opposite end faces of the first connection part 11 and the second connection part 12 and has at least a fastener 141 disposed therein. After the first connection part 11 and the second connection part 12 are aligned horizontally, the fastener 141 is moved to where is between the first connection part 11 and the second connection part 12, so that the first connection part 11 and the second connection part 12 won't be crooked.

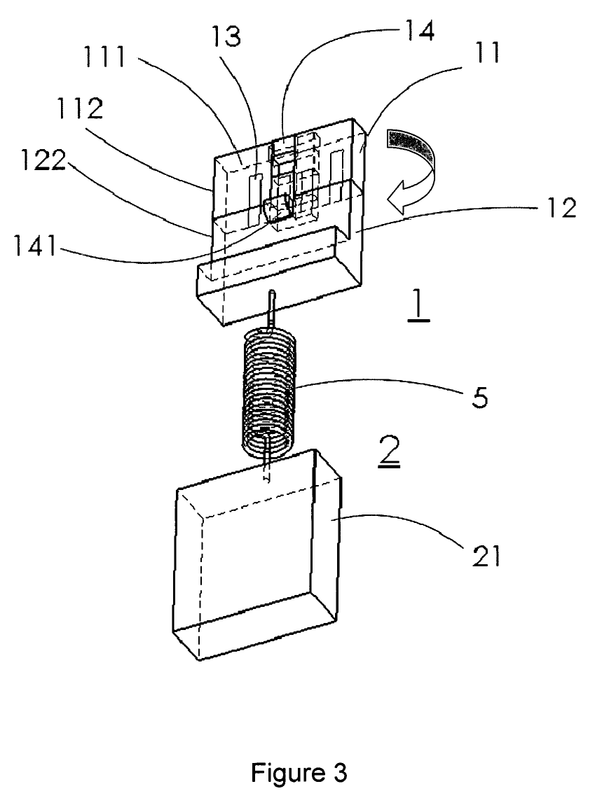

Please refer to FIG. 3 which shows the second preferred embodiment of the foldable connection structure in accordance with the present invention and differs from the first preferred embodiment in that the foldable plug 1 and the main body 2 are detached. The main body 2 is electrically connected with the foldable plug 1 by means of the electrical connection cable 5. The rest of the embodiment is the same as that of the first preferred embodiment.

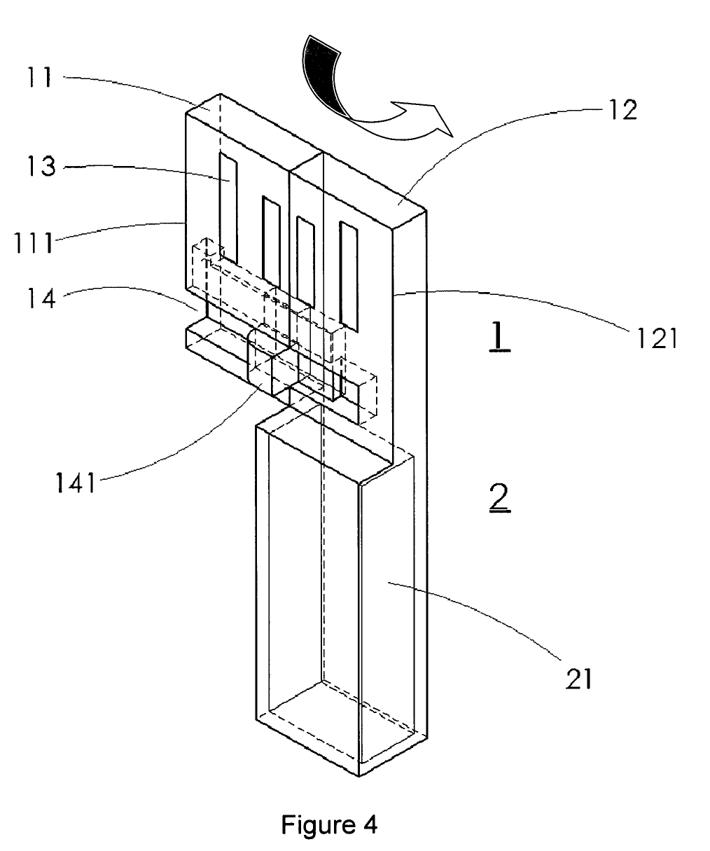

Please refer to FIG. 4 which shows the third preferred embodiment of the foldable connection structure in accordance with the invention and similarly includes a foldable plug 1 containing at least a first connection part 11, at least a second connection part 12, and metal contacts 13 being compatible with a data transmission interface and being electrically connected with an electronic device being compatible with a data transmission interface through the metal contacts 13, in which the contact points 13 can be compatible with a USB transmission interface or an e-SATA transmission interface (only the USB transmission interface is shown as an example), the length of any end face of the first connection part is not greater than 14 mm, and the length of any end face of the second connection part is not greater than 14 mm; and a main body 2 containing at least an electronic component 21.

The main body 2 is electrically connected with the foldable plug 1. The foldable plug 1 and the main body 1 are integrally formed. The metal contacts are disposed on a surface 111, 121 on both the first connection part 11 and the second connection part 12. The foldable plug 1 has at least a track 14, which is provided on the surface (111, 121) of the first connection part 111 and the second connection part 12 same as the surface having the metal contacts 13, communicates with the opposite end faces of the first connection part 11 and the second connection part 12 and has at least a fastener 141 disposed therein. After the first connection part 11 and the second connection part 12 are aligned horizontally, the fastener 141 is moved to where is between the first connection part 11 and the second connection part 12, so that the first connection part 11 and the second connection part 12 won't be crooked.

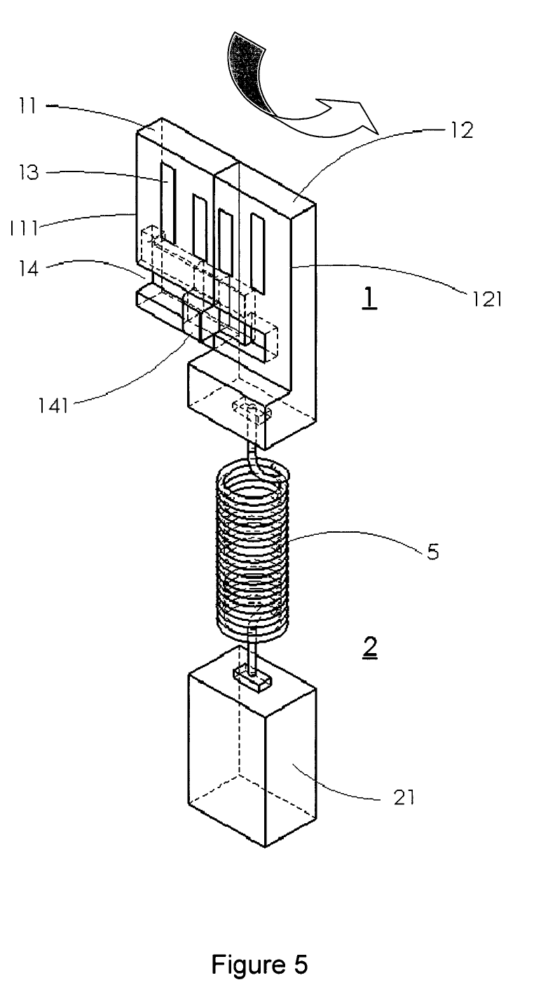

Please refer to FIG. 5 which shows the fourth preferred embodiment of the foldable connection structure in accordance with the present invention and differs from the third preferred embodiment in that the foldable plug 1 and the main body 2 are detached. The main body 2 is electrically connected with the foldable plug 1 by means of the electrical connection cable 5. The rest of the embodiment is the same as that of the third preferred embodiment.

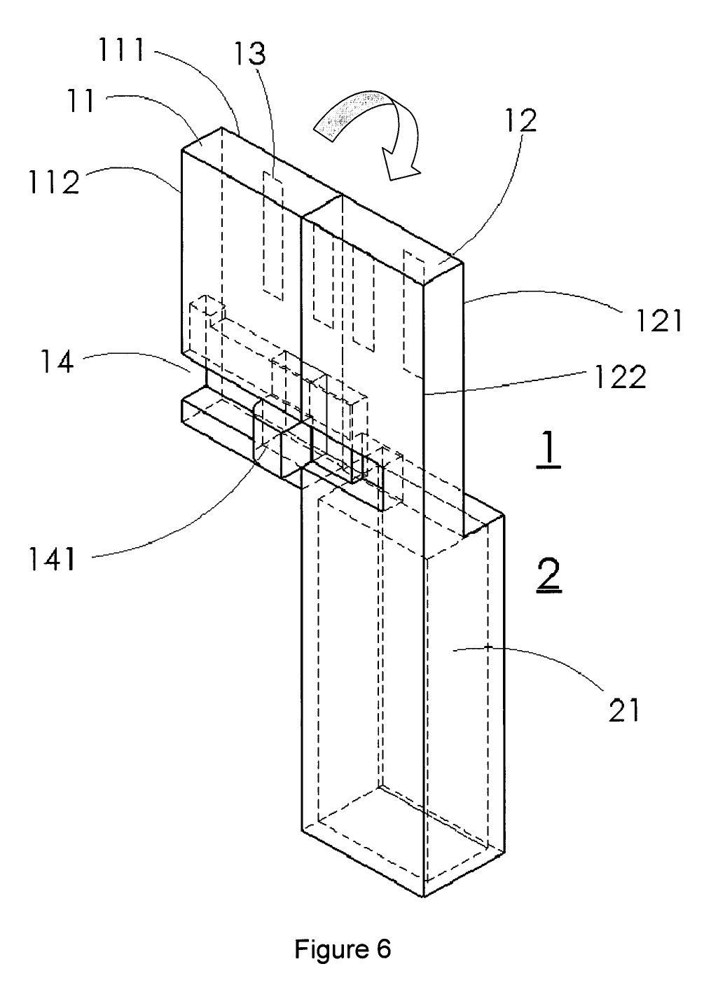

Please refer to FIG. 6 which shows the fifth preferred embodiment of the foldable connection structure in accordance with the present invention and similarly includes a foldable plug 1 containing at least a first connection part 11, at least a second connection part 12, and metal contacts 13 being compatible with a data transmission interface, and being electrically connected with an electronic device being compatible with the data transmission interface through the metal contacts 13, in which the metal contacts 13 can be a USB transmission interface or an e-SATA transmission interface (only the USB transmission interface is shown as an example), the length of any end face of the first connection part is not greater than 14 mm, and the length of any end face of the second connection part is not greater than 14 mm; and a main body 2 containing at least an electronic component 21.

The main body 2 is electrically connected with the foldable plug 1. The foldable plug 1 and the main body 1 are integrally formed. The metal contacts are disposed on a surface 111, 121 of the first connection part 11 and the second connection part 12. The foldable plug 1 has at least a track 14, which is provided on a surface (111, 121) of the first connection part 11 and the second connection part 12 opposing to the surface having the metal contacts 13, communicates with the opposite end faces of the first connection part 11 and the second connection part 12 and has at least a fastener 141 disposed therein. After the first connection part 11 and the second connection part 12 are aligned horizontally, the fastener 141 is moved to where is between the first connection part 11 and the second connection part 12, so that the first connection part 11 and the second connection part 12 won't be crooked.

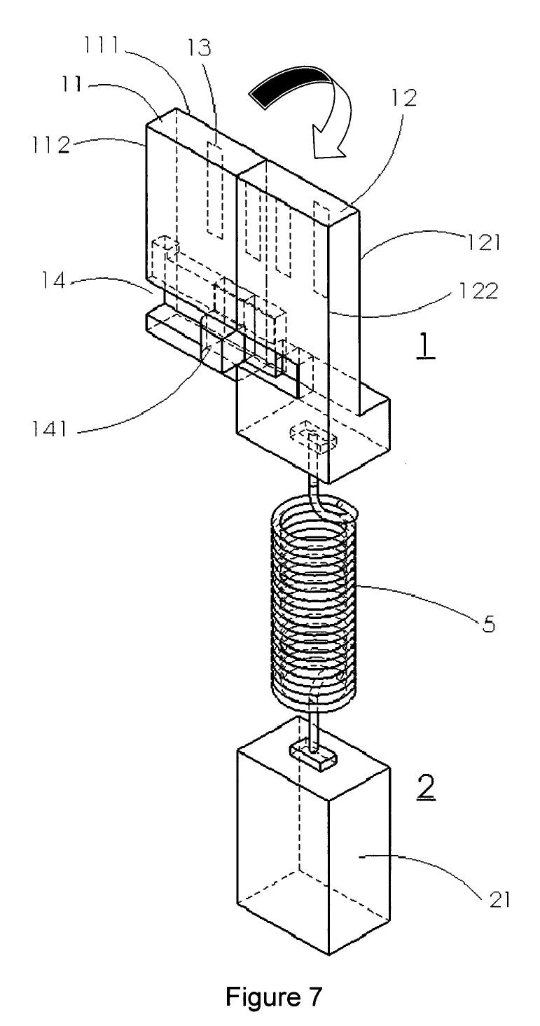

Please refer to FIG. 7 which shows the sixth preferred embodiment of the foldable connection structure in accordance with the present invention and differs from the fifth preferred embodiment in that the foldable plug 1 and the main body 2 are detached. The main body 2 is electrically connected with the foldable plug 1 by means of the electrical connection cable 5. The rest of the embodiment is the same as the fifth preferred embodiment.

In summary, the present invention can address a more flexible design in shrinking the product size of the adopted foldable connection structure with the foldable characteristic of the foldable plug, thereby satisfying the design requirement to be light, thin and tiny. As such, the present invention provides the practical and innovative value to the industry and the application is hereby submitted in accordance with the patent laws.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A foldable connection structure, comprising:
a foldable plug having at least a first connection part, at least a second connection part and a plurality of metal contacts being compatible with a data transmission interface, and being electrically connected with an electronic device being compatible with the data transmission interface through the metal contacts; and
a main body having at least an electronic component and being electrically connected with the foldable plug.

2. The foldable connection structure as claimed in claim 1, wherein the metal contacts are disposed on a surface of the first connection part.

3. The foldable connection structure as claimed in claim 2, wherein the foldable plug has at least a track.

4. The foldable connection structure as claimed in claim 3, wherein the track is provided on a surface of the first connection part and the second connection part opposing to the surface having the metal contacts.

5. The foldable connection structure as claimed in claim 4, wherein the track communicates with opposite end faces of the first connection part and the second connection part and has at least a fastener disposed therein.

6. The foldable connection structure as claimed in claim 1, wherein the metal contacts are disposed on a surface on both the first connection part and the second connection part.

7. The foldable connection structure as claimed in claim 6, wherein the foldable plug has at least a track.

8. The foldable connection structure as claimed in claim 7, wherein the track is provided on a surface of the first connection part and the second connection part same as the surface having the metal contacts.

9. The foldable connection structure as claimed in claim 7, wherein the track communicates with opposite end faces of the first connection part and the second connection part, and has at least a fastener disposed therein.

10. The foldable connection structure as claimed in claim 7, wherein the track is provided on a surface of the first connection part and the second connection part opposing to the surface having the metal contacts.

11. The foldable connection structure as claimed in claim 10, wherein the track communicates with opposite end faces of the first connection part and the second connection part, and has at least a fastener disposed therein.

12. The foldable connection structure as claimed in claim 1, wherein the foldable plug and the main body are integrally formed.

13. The foldable connection structure as claimed in claim 1, wherein the foldable plug and the main body are detachably connected.

14. The foldable connection structure as claimed in claim 1 and 13, wherein the main body is electrically connected with the foldable plug through an electrical connection cable.

15. The foldable connection structure as claimed in claim 1, wherein the metal contacts are compatible with a USB transmission interface.

16. The foldable connection structure as claimed in claim 1, wherein the metal contacts are compatible with an e-SATA transmission interface.

17. The foldable connection structure as claimed in claim 1, wherein a length of any end face of the first connection part is not greater than 14 mm.

18. The foldable connection structure as claimed in claim 1, wherein a length of any end face of the second connection part is not greater than 14 mm.
